(19) United States
(12) Patent Application Publication
(10) Pub. No.: US 2025/0304738 A1
(43) Pub. Date: Oct. 2, 2025

(54) PROCESS FOR MAKING GRAFTED POLYOLEFIN

(71) Applicants: Dow Global Technologies LLC, Midland, MI (US); Dow Silicones Corporation, Midland, MI (US)

(72) Inventors: Chao He, Shanghai (CN); Kainan Zhang, Shanghai (CN); Yabin Sun, Shanghai (CN); Saurav Sengupta, Gilbertsville, PA (US); Jeffrey M. Cogen, Flemington, NJ (US); Xiuhan Yang, Shanghai (CN); Guowei Wang, Shanghai (CN)

(21) Appl. No.: 18/861,713

(22) PCT Filed: Jul. 27, 2022
(86) PCT No.: PCT/CN2022/108127

§ 371 Date: Oct. 30, 2024

(51) Int. Cl. C08F 255/06; C08F 255/02; C08F 255/04; C08J 5/18

(52) U.S. Cl. CPC C08F 255/06; C08F 255/02; C08F 255/04; C08J 5/18; C08J 2351/06

(57) ABSTRACT

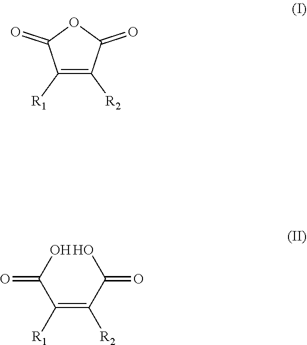

A process for manufacturing a grafted polyolefin having improved yellowness properties, the process including reacting an admixture of: (i) at least one polyolefin; (ii) at least one monomer; wherein the at least one monomer is selected from one or more acid compounds having the following general chemical Formula (I) or Formula (II); wherein in Formula (I) and Formula (II) either R1 or R2 is H, with the proviso that both R1 and R2 is not H; wherein at least one of R1 and R2 is an alkyl or an alkenyl with a carbon number of from 1 to 20; and wherein R1, R2, or both R1 and R2 may further include an ester, a heteroatom, an aromatic, or a halogen; and (iii) at least one free radical initiator to form a grafted polyolefin; wherein the grafted polyolefin has a yellowness index, YIE313, of <30.

### FIELD

The present invention relates to a process for manufacturing a grafted polyolefin; and more specifically, the present invention relates to a grafting process for manufacturing a grafted polyolefin by grafting a polyolefin with a methyl/dimethyl maleic anhydride so as to reduce the yellowing of the grafted polyolefin after grafting the polyolefin with the methyl/dimethyl maleic anhydride.

### BACKGROUND

In many package applications, such as food, medicine, makeup, shipping, electronic component, metal laminate and the like, polyolefins are needed to bond to dissimilar substrates, hence a tie-layer adhesive is needed. Heretofore, maleic anhydride grafted polyolefins (MAH-g-polyolefins) have been widely used in the tie-layer adhesives.

MAH-g-polyolefins are usually produced by grafting maleic anhydride (MAH) onto a polyolefin backbone with the help of organic peroxide via high temperature twin screw extrusion. For unknown reasons, addition of peroxide will often cause undesirable yellowness.

In some color-sensitive applications, low color or colorless materials are required; however, undesirable yellowing or even dark yellow often occurs in MAH-g-polyolefins and its related let-down products. Such materials with undesirable yellowing are not desired for use in color-sensitive applications.

In some cases, a solution to the color problem has been attempted by adding certain additives to the MAH-g-polyolefins. For example, U.S. Pat. No. 6,380,320B1 discloses preparing an anhydride-grafted polymer with improved color properties by mixing in an extruder a polyolefin, an anhydride-providing monomer and an oxo-boron compound additive; and then extruding the resultant anhydride grafted polymer into a shaped article. Although there has been some success in reducing the yellowness of anhydride grafted polymers, there is still a need for lower color or colorless materials for use in color-sensitive applications. Therefore, it is desirous to provide an anhydride grafted polyolefin with reduced yellowness for use in color-sensitive applications using a different composition besides MAH-g-polyolefins alone or with other additives.

U.S. Pat. No. 5,728,776A discloses a process for preparing a graft polyolefin by melt kneading (a) a polyolefin (A), (b) a radical polymerizable monomer (B) which is an unsaturated carboxylic anhydride and is heat treated at 50-250° C. before the graft reaction, and (c) a radical polymerization initiator (C). Component (A) is polypropylene. The unsaturated carboxylic anhydride has a cyclic anhydride structure and is at least one chosen from maleic acid, fumaric acid, itaconic acid and citraconic acid. The unsaturated carboxylic acid is at least one chosen from MAH, itaconic anhydride, citraconic anhydride and cyclopentane dicarboxylic anhydride. Component (C) is an organic peroxide.

CN5859970A discloses a method for improving the grafting efficiency of polyolefin. The method includes weighing the polyolefin, polar monomer (parts of the polar monomer is in a solvent), initiator, and antioxidant according to part by weight. The method includes adding the initiator into the absolute ethyl alcohol, polyolefin, antioxidant and polar monomer solution in a high-speed mixer to mix uniformly. After the volatile solvent of polar monomer is added, the resultant mixture is added into an extruder hopper. Each section temperature of the extruder is between 220° C. and 140° C.; the extruder maintains a main screw rotating speed of from 60 rpm to 400 rpm, and a feeding speed of the screw of from 10 rpm to 80 rpm, while at the same time, the absolute ethyl alcohol solution of initiator according to the different speeds is pumped into the extruder having the different heating sections. The resulting extrudate is then cooled, dried, and cut to obtain the polar monomer graft modified polyolefin particles.

The above two references disclose improving the grafting method of polyolefin. One of the chosen grafting components in the process disclosed in the above references can be MAH. However, there is no disclosure of obtaining a low color or colorless grafted polyolefin product; and there is no mention in the above references that a methyl/dimethyl maleic anhydride can be used to produce a product with improved color. The above references do not disclose using methyl/dimethyl maleic anhydride to replace MAH to reduce and/or solve the color issue.

### SUMMARY

One embodiment of the present invention is directed to a process of manufacturing a grafted polyolefin including grafting a polyolefin with a methyl/dimethyl maleic anhydride such that the grafted polyolefin has improved yellowness properties. The process for manufacturing a grafted polyolefin having improved yellowness properties includes reacting an admixture of: (i) at least one polyolefin; (ii) at least one monomer; wherein the at least one monomer is selected from one or more acid compounds having the following general chemical Formula (I) or Formula (II):

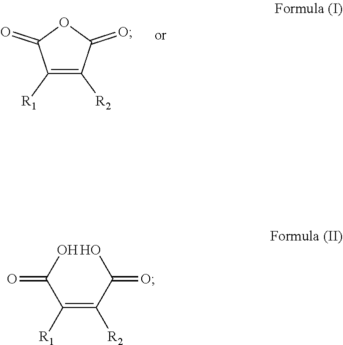

wherein in Formula (I) and Formula (II) either R1 or R2 is H, with the proviso that both R1 and R2 is not H; wherein at least one of R1 and R2 is an alkyl or an alkenyl with a carbon number of from 1 to 20; and wherein R1, R2, or both R1 and R2 may further include an ester, a heteroatom, an aromatic, or a halogen; and (iii) at least one free radical initiator to form a grafted polyolefin; wherein the grafted polyolefin has a yellowness index, YIE313, of <30.

In some embodiments, process of the present invention includes the steps of firstly providing the following components: (i) at least one polyolefin; (ii) at least one monomer; for example, wherein the at least one monomer has the Formula (I) or Formula (II); and (iii) at least one free radical initiator; secondly, mixing the at least one polyolefin, the at least one monomer such as a monomer selected from the group consisting of 3-methylfuran-2,5-dione, 3,4-dimethylfuran-2,5-dione, or a combination thereof, and the at least one free radical initiator to form a reactive admixture; and then reacting the admixture or allowing the reactive admixture to react to form a grafted polyolefin. The resultant grafted polyolefin beneficially exhibits a yellowness index, YIE313, of <30. Thus, the resulting grafted polyolefin can be used for producing a film or other article with low yellowness which, in turn, can be used in color-sensitive applications requiring low color or colorless materials.

One objective of the present invention is to mitigate color formation during grafting of an anhydride to polyolefins. It has been found that methyl/dimethyl maleic anhydride reduces the yellowing of polyolefins after grafting, compared to polyolefins grafted with MAH. Not to be limited to any particular theory, it is theorized that, based on 1H NMR (proton nuclear magnetic resonance) analysis and pyrolysis results, the mechanism of color production in MAH grafting might be the result of the phenol and quinone products present in the final grafted polyolefin prepared by MAH grafting. On the other hand, it is believed that the methyl/dimethyl maleic anhydride grafting suppresses the production of the phenol and quinone products; and thus, providing an anhydride grafted polyolefin product with better color performance.

### DETAILED DESCRIPTION

Temperatures used herein are in degrees Celsius (° C.).

“Room temperature (RT)” and “ambient temperature” herein means a temperature between 20° C. and 26° C., unless specified otherwise.

The term “composition,” as used herein, refers to a mixture of materials which comprises the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; and the like).

As used throughout this specification, the abbreviations given below have the following meanings, unless the context clearly indicates otherwise: “=” means “equal(s)” or “equal to”; “<” means “less than”; “>” means “greater than”; “≤” means “less than or equal to”; ≥” means “greater than or equal to”; “@” means “at”; ppm=parts per million; ppb=parts per billion; ppt=parts per trillion; BV/hr=bed volume/hour(s); “MT”=metric ton(s); g=gram(s); mg=milligram(s); Kg=kilogram(s); L=liters; g/L=gram(s) per liter; μL=microliter(s); “g/cm³” or “g/cc”=gram(s) per cubic centimeter; g/10 min=gram(s) per 10 minutes; mg/mL=milligrams per milliliter; “kg/m³=kilogram(s) per cubic meter; ppm=parts per million by weight; pbw=parts by weight; rpm=revolutions per minute; m=meter(s); mm=millimeter(s); cm=centimeter(s); μm=micron(s) or micrometer(s); nm=nanometer(s); min=minute(s); s=second(s); ms=millisecond(s); hr=hour(s); Pa=pascals; MPa=megapascals; Pa-s=Pascal second(s); mPa-s=millipascal second(s); g/mol=gram(s) per mole(s); g/eq=gram(s) per equivalent(s); Mₙ=number average molecular weight; M_{w}=weight average molecular weight; pts=part(s) by weight; 1/s or sec⁻¹=reciprocal second(s) [s⁻¹]; ° C.=degree(s) Celsius; ° C./min=degree(s) Celsius per minute; psi=pounds per square inch; kPa=kilopascal(s); %=percent; vol %=volume percent; mol %=mole percent; and wt %=weight percent.

Specific embodiments of the present invention are described herein below. These embodiments are provided so that this disclosure is thorough and complete; and fully conveys the scope of the subject matter of the present invention to those skilled in the art.

Unless stated to the contrary, implicit from the context, or customary in the art, all percentages, parts, ratios, and the like amounts are based on weight, all temperatures are in ° C., and all test methods are current as of the filing date of this disclosure.

Generally, the process of the present invention for manufacturing a grafted polyolefin having improved yellowness properties includes reacting a reaction admixture, or allowing the reaction mixture to react, where the reactive admixture includes the following components: (i) at least one polyolefin; (ii) at least one monomer; wherein the at least one monomer is selected from the group consisting of 3-methylfuran-2,5-dione, 3,4-dimethylfuran-2,5-dione, or a combination thereof; and (iii) at least one free radical initiator. By admixing the at least one polyolefin, the at least one monomer, and the at least one free radical initiator, under process conditions such as an elevated temperature, a grafted polyolefin is formed; wherein the grafted polyolefin has a yellowness index, YIE313, of <30. Other optional additives or agents, or compounds, optional component (iv), can be added to the above polyolefin composition, if desired.

Component (i) of the formulation or composition used to produce the grafted polyolefin of the present invention having improved yellowness properties is at least one polyolefin. Exemplary of the polyolefin, component (i), useful in the present invention include: polyethylene; polypropene; styrene-ethylene-butene-styrene; alpha olefin homo or copolymers; ethylene octene copolymer; ethylene hexene copolymer; ethylene propene copolymer; ethylene; propene; norbornene diene copolymer; copolymers of ethylene and unsaturated esters such as vinyl acetate and alkyl acrylates (such as ethylene-vinyl acetate, ethylene-ethyl acrylate, and the like); and mixtures thereof.

Exemplary of some commercial polyolefins useful for preparing the grafted polyolefin of the present invention includes for example NORDEL™ 4725, DOW™ LDPE 310E, VERSIFY™ 2300 (all available from The Dow Chemical Company); and mixtures thereof.

In one general embodiment, the concentration of the polyolefin, component (i), of the present invention, useful for preparing the grafted polyolefin composition can be in the range of from 90.0 wt % to 99.9 wt %, based on the total weight of all components in the composition; from 95.0 wt % to 99.0 wt % in another embodiment, and from 97.0 wt % to 99.0 wt % in still another embodiment.

Component (ii) of the formulation or composition used to produce the grafted polyolefin of the present invention having improved yellowness properties is at least one monomer. For example, the monomer, component (ii), can include 3-methylfuran-2,5-dione; 3,4-dimethylfuran-2,5-dione; 3-ethylfuran-2,5-dione; 3,4-diethylfuran-2,5-dione; and combination thereof.

The concentration of the monomer, component (ii), useful in preparing a grafted polyolefin having improved yellowness properties of the present invention can be from 0.05 wt % to 5.0 wt %, based on the total weight of all components in the composition, in one general embodiment, from 0.5 wt % to 3.0 wt % in another embodiment, and from 1.0 wt % to 2.5 wt % in still another embodiment. Using a concentration above the 5.0 wt % level may be difficult to graft the polymer; and below the 0.05 wt % level does not provide sufficient grafting on the polymer.

Component (iii) of the formulation or composition used to produce the grafted polyolefin of the present invention having improved yellowness properties is at least one free radical initiator. Any free radical initiator known to those skilled in the art of grafting can be used in the present invention. For example, the free radical initiator, component (iii), can include: dialkyl peroxides and hydroperoxides; diacyl peroxides; peresters; organic polyoxides; azo-compounds; and combination thereof.

Exemplary of some commercial free radical initiators useful for preparing the grafted polyolefin of the present invention includes dicumyl peroxide (“DCP”); benzoyl peroxide (“BPO”); azobisisobutyronitrile (“AIBN”); tert-butyl peroxybenzoate; di-tert-amyl peroxide (“DTAP”); bis(t-butyl-peroxy isopropyl)benzene (“BIPB”); isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3; 1,1-bis(t-butylperoxy) 3,3,5-trimethylcyclohexane; isopropylcumyl cumylperoxide; butyl 4,4-di(tert-butylperoxy) valerate; di(isopropylcumyl) peroxide; 1,1-di-(tert-butylperoxy)cyclohexane (e.g., Luperox® 331″); 1,1-di-(tert-amylperoxy)cyclohexane (e.g., Luperox 531®); tert-butyl peroxyacetate (“TBPA”); tert-amyl peroxyacetate (“TAPA”); 2,5-dimethyl-2,5-di(tert-butylperoxy) hexane (e.g., Luperox® 101); tert-butylperoxy-2-ethylhexyl carbonate (“TBEC”); 3,6,9-triethyl-3,6,9-trimethyl-1,4,7-triperoxonane (e.g., Trigonox® 301); and mixtures thereof.

In one preferred embodiment, the free radical initiator component (iii) of the composition of the present invention comprises, consists essentially of, or consists of: DCP; BPO; and mixtures thereof.

The concentration of the free radical initiator, component (iii), useful in preparing a grafted polyolefin having improved yellowness properties of the present invention can be from 0.01 wt % to 3.00 wt %, based on the total weight of all components in the composition, in one general embodiment, from 0.05 wt % to 2.00 wt % in another embodiment, and from 0.1 wt % to 1.00 wt % in still another embodiment. Using a concentration above the 3.00 wt % level may result in gelling; and below the 0.1 wt % level does not provide sufficient grafting on the polymer.

Optionally, the composition of the present invention may be formulated with a wide variety of additives to enable performance of specific functions while maintaining the excellent benefits/properties of the present invention composition. For example, the optional additives, component (iv), useful in the composition of the present invention may be selected from the group consisting of colorants; mineral fillers, process oils; flame retardants, foaming agents; process aids, antioxidants; and mixtures thereof.

The optional compounds, when used in preparing the grafted polyolefin having improved yellowness properties of the present invention, can be present in an amount generally in the range of from 0 wt % to 10 wt % in one embodiment; from 0.01 wt % to 5 wt % in another embodiment; and from 0.1 wt % to 1 wt % in still another embodiment.

In one broad embodiment, the process for making a grafted polyolefin having improved yellowness properties of the present invention includes reacting an admixture of: (i) at least one polyolefin; (ii) at least one monomer; wherein the at least one monomer is selected from the group consisting of 3-methylfuran-2,5-dione; 3,4-dimethylfuran-2,5-dione; or a combination thereof; and (iii) at least one free radical initiator, to form a grafted polyolefin; wherein the grafted polyolefin has a yellowness index, YIE313, of <30. One or more additional optional components, additives, agents, or compounds, component (iv), may be added to the composition, if desired.

The above-described composition, formulation or admixture is formed by mixing, admixing, or blending: (i) the at least one polyolefin; (ii) the at least one monomer; wherein the at least one monomer is selected from the group consisting of 3-methylfuran-2,5-dione; 3,4-dimethylfuran-2,5-dione; or a combination thereof; and (iii) the at least one free radical initiator; under process conditions, to form a grafted polyolefin; wherein the grafted polyolefin has a yellowness index, YIE313, of <30. For example, the components (i), (ii), (iii), and optionally (iv), can be mixed together in the desired concentrations discussed above to form a reactive admixture; and then the reactive admixture can be heated at a temperature of from 140° C. to 220° C. in one embodiment; from 160° C. to 220° C. in another embodiment; and from 180° C. to 220° C. in still another embodiment to provide the reaction for forming the grafted polyolefin. If desired, the optional additives, component (iv), can be mixed with any one or more of the components (i), (ii) and (iii). The order of mixing of the components is not critical; and two or more components can be mixed together followed by addition of the remaining components. The formulation components may be mixed together by any conventional mixing process and equipment as known to those skilled in the art of mixing.

In other embodiments, the process for making the composition of the present invention and forming the grafted polyolefin having improved yellowness properties includes the steps of: (a) providing the following components: (i) at least one polyolefin; (ii) at least one monomer; wherein the at least one monomer is selected from the group consisting of 3-methylfuran-2,5-dione; 3,4-dimethylfuran-2,5-dione; or a combination thereof; (iii) at least one free radical initiator; and (iv) optionally an additive; and (b) mixing the at least one polyolefin, the at least one monomer, the at least one free radical initiator, and any optional additive(s) if desired, to form a reactive admixture. The mixing can be carried out using methods and equipment known to the skilled in the art such as an extruder to form the reactive admixture; and (c) reacting the reactive admixture, or allowing the reactive admixture to react, for example, by heating the admixture at an elevated temperature (e.g., a temperature greater than the melting temperature of the polyolefin) to form the grafted polyolefin; wherein the grafted polyolefin has a yellowness index, YIE313, of <30.

For example, in step (c) above, the reactive admixture of components (i), (ii), (iii), and optionally (iv), discussed above can be heated at a temperature of from 140° C. to 240° C. in one embodiment; from 160° C. to 240° C. in another embodiment; and from 180° C. to 240° C. in still another embodiment sufficient to form the grafted polyolefin of the present invention.

The resultant grafted polyolefin formed as described above can be further processed to form a shaped or finished part or article by methods well known to those skilled in the art.

The grafted polyolefin of the present invention prepared in accordance with the methods described above, has several advantageous properties and/or benefits. For example, some of the properties/benefits exhibited by the grafted polyolefin of the present invention include, for example, the grafted polyolefin has a yellowness index, YIE313, of <30 in one general embodiment.

In some embodiments, the grafted polyolefin has a yellowness index, YIE313, of <30 in one general embodiment, <15 in another embodiment, and <5 in still another embodiment. In other embodiments, the grafted polyolefin has a yellowness index, YIE313, of from 0 to <30 in one embodiment; from 10 to <30 in another embodiment; and from 20 to <30 in still another embodiment. The yellowness index is measured by the following procedure described in the yellowing index testing in the Examples including conducting the test on a Hunterlab ColorQuest XE (available from Hunterlab), having a light source of D65 with 10° observer and reflection model, using a ˜2 mm monolayer film prepared by the process described in the Examples.

The grafted polyolefin of the present invention can be used, for example, as an adhesion layer, a compatibilizer, an impact modifier, a crosslinkable polyolefin, and the like, in applications where such materials are useful.

### Examples

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of the compositions described herein. Unless otherwise stated all parts and percentages are by weight on a total weight basis.

### Designations

Some of the designations and abbreviations used for some of the materials and items used in the Examples are as follows:
“MAH” stands for maleic anhydride.
“MFD” stands for 3-methylfuran-2,5-dione.
“DMFD” stands for 3,4-dimethylfuran-2,5-dione.
“DCP” stands for dicumyl peroxide.
“MI” stands for melt index.
“ENB” stands for ethylidene norbornene.
“FTIR” stands for Fourier transform infrared.
“ATR” stands for attenuated total reflectance.
“TD” stands for thermal desorption.
“Py” stands for pyrolysis.
“EGA” stands for evolved gas analysis.
“GC” stands for gas chromatography.
“MS” stands for mass spectrometry
“EI” stands for electron impact which is one way of ionization.
“PFTBA” stands for perfluorotributylamine, a chemical used to tune a mass spectrometer.
“CIELAB color space” or “L*a*b*” is a well-known color space defined by the International Commission on Illumination (abbreviated CIE). The designation “L*a*b*” expresses color as three values: “L*” for perceptual lightness, and “a*” and “b*” for the four unique colors of human vision: red, green, blue, and yellow. It is useful in the industry for detecting small differences in color.

### Raw Materials

The pertinent raw materials (ingredients) used in the Examples are described in Table I.

TABLE I
Raw Materials/Ingredients

| Ingredient | | Chemical Description, Chemical | |
|---|---|---|---|
| Type | Product Name | Formula, or Structure | Supplier |
| Polymer1 | NORDEL ™ 4725 | A low viscosity semi-crystalline | The Dow |
| | | ethylene-propylene-diene | Chemical |
| | | terpolymer (EPDM) grade having a | Company |
| | | density of 0.88 g/cm³ | (Dow) |
| Polymer2 | DOW ™ LDPE | A low density polyethylene having | Dow |
| | 310E | a MI of 0.75 g/10 min (@ 190° C., | |
| | | 2.16 kg) and a density of 0.923 | |
| | | g/cm³ | |
| Polymer3 | VERSIFY ™ 2300 | An ethylene propylene copolymer | Dow |
| | | grade having a MI of 2 g/10 min (@ | |
| | | 230° C., 2.16 kg) and a density of | |
| | | 0.866 g/cm³ | |
| Anhydride1 | MAH | Maleic anhydride having the following chemical structure: 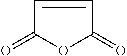 | TCI |
| Anhydride2 | MFD | 3-Methylfuran-2,5-dione; a citraconic anhydride having the following chemical structure: 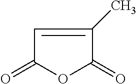 | TCI |
| Anhydride3 | DMFD | 3,4-Dimethylfuran-2,5-dione; a dimethyl maleic anhydride having the following chemical structure: 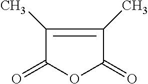 | TCI |
| Peroxide1 | DCP | Dicumyl peroxide having the following chemical structure: 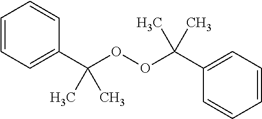 [SMILES: CC(C)(OOC(C)(C)c1ccccc1)c1ccccc1] | Shanghai Aladdin Biochemical Technology Co., Ltd. |
| Solvent1 | xylene | Ph(CH₃)₂ | Sigma-Aldrich |
| Solvent2 | methanol | CH₃OH | Sigma-Aldrich |

### Formulations

### General Process for Preparing the Grafted Polyolefin

The ingredients/formulations used for producing the grafted polyolefins in the Examples are described in Table II. Components (i)-(iii) and optionally (iv) were admixed using a Brabender mixer and using the following general process steps: (1) the polymer (e.g., Polymer1, Polymer2, or Polymner3), was fed into the Brabender mixer which was set at a temperature of 120° C. with a rotor speed of 10 rpm; (2) the peroxide (e.g., Peroxide1) and the anhydride (e.g., Anydride1, Anhydride2 or Anhydride3) was fed into the polymer melt in the mixer at the set temperature to form a reactive admixture; (3) the resulting admixture of ingredients was subjected to a final mixing at a temperature of 180° C. and at a rotor speed of 45 rpm for 10 min; and (4) the resulting compound from the mixer was collected for analysis.

TABLE II
Formulations

| | Comp. | Comp. | Comp. | Inv. | Inv. | Inv. | Inv. | Inv. | Inv. |
|---|---|---|---|---|---|---|---|---|---|
| | Ex. A | Ex. B | Ex. C | Ex. 1 | Ex. 2 | Ex. 3 | Ex. 4 | Ex. 5 | Ex. 6 |
| Ingredient | | | | | | | | | |
| NORDEL ™ | 43.0000 | | | 43.0000 | | | 43.0000 | | |
| 4725, g | | | | | | | | | |
| DOW ™ LDPE | | 43.0000 | | | 43.0000 | | | 43.0000 | |
| 310E, g | | | | | | | | | |
| VERSIFY ™ | | | 43.0000 | | | 43.0000 | | | 43.0000 |
| 2300, g | | | | | | | | | |
| MAH, g | 1.7200 | 1.7200 | 1.7200 | | | | | | |
| MFD, g | | | | 1.9657 | 1.9657 | 1.9657 | | | |
| DMFD, g | | | | | | | 2.2114 | 2.2114 | 2.2114 |
| DCP, g | 0.0860 | 0.0860 | 0.0860 | 0.0860 | 0.0860 | 0.0860 | 0.0860 | 0.0860 | 0.0860 |
| Calculation | | | | | | | | | |
| Total polymer | 95.97 | 95.97 | 95.97 | 95.45 | 95.45 | 95.45 | 94.93 | 94.93 | 94.93 |
| content, wt % | | | | | | | | | |
| Total peroxide | 0.19 | 0.19 | 0.19 | 0.19 | 0.19 | 0.19 | 0.19 | 0.19 | 0.19 |
| content, wt % | | | | | | | | | |
| Total | 0.018 | 0.018 | 0.018 | 0.018 | 0.018 | 0.018 | 0.018 | 0.018 | 0.018 |
| anhydride, mol | | | | | | | | | |

### Analysis and Testing Methods

### FTIR Testing

Samples of grafted polyolefin polymers were examined by Fourier Transform Infrared (FTIR) spectroscopy using a single-reflection attenuated total reflectance (ATR) attachment equipped with a diamond crystal. The depth of penetration during the ATR analysis was estimated to be 2 μm. A spectrum was collected using a Thermo Electron Nicolet 5700 Optical Bench (available from Thermo Electron) with 32 scans at 4 cm-1 resolution. The successful grafting of the samples was demonstrated using FTIR analysis.

### Yellowing Index Test

The method used to measure the yellowing index of a film sample (referred to herein as the “yellowing index test” or “YI Test”) was conducted as follows: A monolayer film sample was prepared by hot pressing ˜20 g of grafted polyolefin polymer with a hot press machine to obtain a ˜2 mm monolayer film as follows:

1. A mold having the following dimensions: 100 mm×100 mm×2 mm, was used.

2. Approximately 20 g of pellets/bulks were weighed and placed in the mold.

3. The mold was sandwiched between the upper and lower plates of the hot press machine at 0 MPa; and the mold was preheated for 10 min at 120° C.

4. The mold was held at 120° C. and 5 MPa for 0.5 min.

5. The mold was held at 120° C. and 10 MPa for 0.5 min.

6. After venting (to degas any potential air present in the resin) 8 times, the mold was held for ˜13 min at 180° C. and 10 MPa.

7. The mold was cooled from 180° C. to 60° C. within 10 min at 10 MPa.

8. The monolayer film formed in the mold was taken out of the mold for testing.

The resulting monolayer film was subjected to the YI Test. The yellowing index testing using the YI Test of the monolayer film prepared as described above was conducted on a Hunterlab ColorQuest XE (available from Hunterlab), having a light source of D65 with 10° observer and reflection model. The values obtained for the measurements of Yellowing Index (YIE313) using the YI Test are described in Table III. It is noted that the YIE313 number is dependent on the sample preparation. The ASTM D1925 procedure is a standard of how to test for the index YIE313 number, but the ASTM D1925 procedure does not cover the preparation of the specimen to be tested for yellowness. The YIE313 number is only comparable between samples that are prepared using the same sample preparation procedure.

TABLE III
Property/Performance of Grafted Polyolefin Product

| Property | Comp. | Comp. | Comp. | Inv. | Inv. | Inv. | Inv. | Inv. | Inv. |
|---|---|---|---|---|---|---|---|---|---|
| Tested | Ex. A | Ex. B | Ex. C | Ex. 1 | Ex. 2 | Ex. 3 | Ex. 4 | Ex. 5 | Ex. 6 |
| YIE313 | 45.25 | 32.31 | 40.42 | 26.26 | 15.88 | 29.50 | 22.54 | 14.71 | 23.69 |

### Discussion of Results

The results described in the above-described Tables show that the grafted polyolefins of the Inventive Examples have a much better color performance than the grafted polyolefins of the Comparative Examples. For example, the polyolefin used in Inv. Ex. 1 and 4 is the same as the polyolefin used in Comp. Ex. A; and when the grafted polyolefins of Inv. Ex. 1 and 4 are compared to the grafted polyolefin of Comp. Ex. A, the grafted polyolefins of Inv. Ex. 1 and 4 showed a much better color (less yellowing) than the grafted polyolefin of the Comp. Ex. A wherein the polyolefin grafted in the Comp. Ex. A is grafted with MAH.

In another example, the polyolefin used in Inv. Ex. 2 and 5 is the same as the polyolefin used in Comp. Ex. B; and when the grafted polyolefins of Inv. Ex. 2 and 5 are compared to the grafted polyolefin of Comp. Ex. B, the grafted polyolefins of Inv. Ex. 2 and 5 showed a much better color (less yellowing) than the grafted polyolefin of Comp. Ex. B wherein the polyolefin grafted in the Comp. Ex. B is grafted with MAH.

In still another example, the polyolefin used in Inv. Ex. 3 and 6 is the same as the polyolefin used in Comp. Ex. C; and when the grafted polyolefins of Inv. Ex. 3 and 6 are compared to the grafted polyolefin of Comp. Ex. C, the grafted polyolefins of Inv. Ex. 3 and 6 showed a much better color (less yellowing) than the grafted polyolefin of Comp. Ex. C wherein the polyolefin grafted in the Comp. Ex. C is grafted with MAH.

What is claimed is:

1. A process for manufacturing a grafted polyolefin having improved yellowness properties, the process comprising reacting an admixture of:
(i) at least one polyolefin;
(ii) at least one monomer; wherein the at least one monomer is selected from one or more acid compounds having the following general chemical Formula (I): 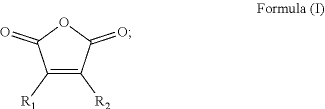
or
wherein the at least one monomer is selected from one or more hydrolysis acid compounds having the following general chemical Formula (II): 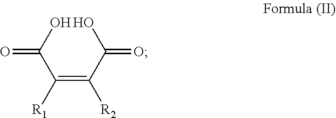
wherein in Formula (I) and Formula (II) either R1 or R2 is H, with the proviso that both R1 and R2 is not H; wherein at least one of R1 and R2 is an alkyl or an alkenyl with a carbon number of from 1 to 20; and wherein R1, R2, or both R1 and R2 may further include an ester, a heteroatom, an aromatic, or a halogen; and
(iii) at least one free radical initiator to form a grafted polyolefin; wherein the grafted polyolefin has a yellowness index, YIE313, of less than 30, as determined according to the YI Test.

2. The process of claim 1, wherein the grafted polyolefin has a yellowness index, YIE313, as determined according to the YI Test, of from 0 to less than 30.

3. The process of claim 1, wherein the grafted polyolefin grafted with the monomer of component (ii) has an improved yellowness index, YIE313, as determined according to the YI Test, of at least from
30 percent to 70 percent compared to a grafted polyolefin grafted with maleic anhydride.

4. The process of claim 1, wherein the at least one monomer is selected from the group consisting of 3-methylfuran-2,5-dione, 3,4-dimethylfuran-2,5-dione, or a combination thereof.

5. The process of claim 1, wherein the at least one polyolefin is a polyethylene; an ethylene alpha olefin copolymer; an ethylene alpha olefin diene terpolymer; and mixtures thereof.

6. The process of claim 1, wherein the at least one free radical initiator is peroxide selected from the group consisting of; dicumyl peroxide; bis(t-butyl-peroxy isopropyl)benzene; t-butylcumylperoxide; di-t-butyl peroxide; 2,5-bis(t-butylperoxy)-2,5-dimethylhexane; 2,5-bis(t-butylperoxy)-2,5-dimethylhexyne-3; and 3,6,9-triethyl-3,6,9-trimethyl-1,4,7-triperoxonane.

7. The process of claim 1, wherein the concentration of the at least one polyolefin is from
95.0 weight percent to 99.9 weight percent; wherein the concentration of the at least one monomer is from 0.1 weight percent to 5.0 weight percent; and wherein the concentration of the at least one free radical initiator is from 0.01 weight percent to 3.0 weight percent.

8. The process of claim 1, wherein the process is carried out at a temperature above the melting point of the polyolefin.

9. The process of claim 1, wherein the process is carried out at a temperature of from 50° C. to
350° C.

10. The process of claim 1, wherein the process is carried out in a continuous process using an extruder; or wherein the process of claim 1 is carried out in a batch process using a mixing vessel.

11. The process of any one of the preceding claims, further including the step of forming the grafted polyolefin into a shaped product or article.

12. A product or article formed from the process of any one of the preceding claims.

13. The product or article of claim 12, wherein the product or article is a film, pellet or granule.

14. A composition for manufacturing a grafted polyolefin having improved yellowness properties, the composition comprising a reaction mixture of:
(i) at least one polyolefin;
(ii) at least one monomer; wherein the at least one monomer is selected from one or more acid compounds having the following general chemical Formula (I): 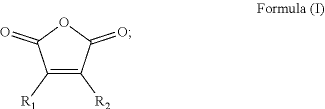
or
wherein the at least one monomer is selected from one or more hydrolysis acid compounds having the following general chemical Formula (II): 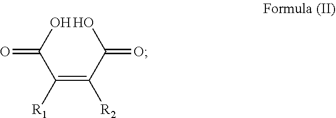
wherein in Formula (I) and Formula (II) either R1 or R2 is H, with the proviso that both R1 and R2 is not H; wherein at least one of R1 and R2 is an alkyl or an alkenyl with a carbon number of from 1 to 20; and wherein R1, R2, or both R1 and R2 may further include an ester, a heteroatom, an aromatic, or a halogen; and
(iii) at least one free radical initiator to form a grafted polyolefin; wherein the grafted polyolefin has a yellowness index, YIE313, of less than 30.

15. The composition of claim 14, wherein the grafted polyolefin grafted with the monomer of component (ii) has an improved yellowness index, YIE313, as determined according to the YI Test, of at least from 30 percent to 70 percent compared to a grafted polyolefin grafted with maleic anhydride.
